(19) United States
(12) Patent Application Publication
(10) Pub. No.: US 2021/0247479 A1
(43) Pub. Date: Aug. 12, 2021

(54) Object Locating Device

(71) Applicant: Matthew E. Hendricks, Blue River, WI (US)

(72) Inventor: Matthew E. Hendricks, Blue River, WI (US)

(21) Appl. No.: 16/891,284

(22) Filed: Jun. 3, 2020

Related U.S. Application Data
(60) Provisional application No. 62/971,162, filed on Feb. 6, 2020.

(51) Int. Cl. G01S 5/02; H04W 4/029; H04W 4/80; G06F 16/332

(52) U.S. Cl. CPC G01S 5/0231; G06F 16/3329; H04W 4/80; H04W 4/029

(57) ABSTRACT

A device for locating lost objects using a digital assistant. The locating device is attached or tagged to a household object that is commonly lost or misplaced, such as a television remote or a set of keys. The locating device is Wi-Fi enabled and configured to pair with a digital assistant stored on a smart device, such as a smart phone, a computer, or a smart speaker. The locating device comprises a tracking component for communicating with the digital assistant. When a user audibly prompts the digital assistant to locate the tagged object, the digital assistant signals the tracking component to initiate an audible or visual signal from the locating device.

### CROSS-REFERENCE

The present application claims priority to and the benefit of U.S. Provisional Application No. 62/971,162 filed on Feb. 6, 2020, which is incorporated herein by reference in its entirety.

### BACKGROUND

The present invention relates generally to a new and improved object locating device. More specifically, the present invention relates to a locating device that can work in conjunction with a digital assistant on a smart device to help users locate lost or stolen items. The locating device may be placed on or attached to items that are often misplaced, such as a television remote control or a mobile phone. The locating device enables the user to audibly address the digital assistant to ask the locating device to help locate the missing item. The locating device ensures that important items can be located quickly and easily using one's existing digital assistant.

We all lose most everyday possessions occasionally, some of us more often than others. However, there are items that seem to be lost more than others. Individuals commonly misplace items such as the television remote control, a set of keys, or their mobile phone. Locating these misplaced items can be a time consuming and frustrating process. Often times the misplaced item cannot be located and has to be replaced. Additionally, the elderly or memory compromised individuals lose items on a more frequent basis. There are systems and strategies commonly used to locate the lost items. Checking the messiest area of the house is a good strategy as clutter can help to hide objects. Looking around and under larger items such as a couch or car interior is another. Other people use memory aids or similar strategies to start a search.

Fortunately, there are now also electronic options to help locate lost or misplaced objects. Radiofrequency identification (RFID) tracking technology, Wi-Fi, and global positioning system tracking chips are commonplace systems used for this purpose. Applications for these systems include locating lost pets, supply chain tracking, etc. These systems tend to be relatively expensive and overly sophisticated for simply finding a lost household item.

Many households now utilize smart speakers and digital assistants, such as Google Assistant®, Amazon Alexa®, and Apple Siri®. These devices are used to improve the daily quality of life for users. They are relatively inexpensive and are great multitasking tools. The user can use them for a wide variety of tasks, such as playing digital music, as a reference or news source, to create shopping lists, to set reminders, to function as digital calendars, etc. Connecting the locating device of the present invention to an existing digital assistant would allow users to quickly locate missing items without the need for a more sophisticated tracking system.

Google Assistant® is an artificial intelligence-powered virtual assistant developed by Google® that is primarily available on mobile and smart home devices. The Google Assistant® can engage in two-way conversations and is deployed on a wide variety of Android devices, including smartphones and the Google Home® voice-activated speaker. Users primarily interact with the digital assistant through natural voice, although keyboard input is also accepted. The Assistant offers voice commands, voice searching, and voice-activated device control providing conversational interactions. It is also compatible with a wide variety of linkable devices, such as lighting or environmental controls, appliances, etc.

Therefore, there exists a long felt need in the art for an improved locating device designed for interaction with a digital assistant. The present invention in one exemplary embodiment discloses a locating device that works with an existing digital assistant, such as Google Assistant®, to help a user find a lost, misplaced, or stolen item. The system includes a locating device that can be attached to an object to be tracked, such as a television remote or a set of keys. The locating device allows the user to address the digital assistant to ask the locating device to locate the object to be located.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a locating device for use with a digital assistant. The digital assistant is an artificial intelligence-powered virtual assistant activated via a smart device, such as a smart phone, a computer, or a smart speaker. The locating device is configured to pair wirelessly with the digital assistant via Wi-Fi. The locating device is attachable to an object to be located, such as a television remote or a set of keys.

The locating device comprises a tracking component and a location indicating component. The tracking component comprises a communication receiving element and a communication transmitting element. The communication transmitting element is used to pair the locating device with the digital assistant. The communication receiving element is used to receive a wireless communication or instruction from the digital assistant. The location indicating component is in electronic communication with the communication receiving element. A voice command from a user initiated the communication between the digital assistant and the tracking component. Once the communication receiving element of the tracking component receives the communication, the tracking component activates the location indicating component.

The location indicating component comprises a speaker. The location indicating component may further comprise a light emitting element. When the location indicating component is activated, the speaker emits an audible alert indicating the location of the object to be located. Alternatively, when the location indicating element is activated, the light emitting element emits a visible alert indicating the location of the object to be located. Alternatively, the location indicating component could emit an audible alert and a visual alert simultaneously.

The locating device further comprises a power source embedded within the locating device in electrical communication with both the tracking component and the location indicating component. The locating device further comprises an attachment component. The attachment component is a typically a mechanical or adhesive fastener. The attachment component is used to removably attach the locating device to the object to be located.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a locating device of the present invention installed on an object to be located linked to a smart device having a digital assistant in accordance with the disclosed architecture.

FIG. 2 illustrates a perspective view of the locating device of the present invention installed on television remote in accordance with the disclosed architecture.

FIG. 3 illustrates a perspective view of the locating device of the present invention installed on key ring in accordance with the disclosed architecture.

FIG. 4A illustrates a top view of the locating device of the present invention in accordance with the disclosed architecture.

FIG. 4B illustrates a bottom view of the locating device of the present invention in accordance with the disclosed architecture.

FIG. 5 illustrates a flowchart of a tracking component, a location indicating component, and a power source of the locating device of the present invention in accordance with the disclosed architecture.

FIG. 6 illustrates a perspective view of a user finding the object to be located using the locating device of the present invention in accordance with the disclosed architecture.

FIG. 7 illustrates a close-up perspective view of the locating device of the present invention alerting the user of a location of the object to be located in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention discloses a unique locating system that works with Google® and other smart devices, such as smart phones, tablets, computers, smart speakers, or the like. The locating device assists users in locating lost, misplaced, or stolen items. The location device is Wi-Wi enabled and can be placed on common household items, such as a television remote, a set of keys, a wallet, and the like. The locating device enables the user to audibly address their digital assistant, such as Google Assistant®, Amazon Alexa®, and Apple Siri®, to ask the system to locate the missing item. Once queried, the digital assistant communicates with the locating device via Wi-Fi to activate an audible noise or other audible indicator from the locating device. The locating device ensures that important items can be quickly and easily located using one's home network.

The locating device works via pairing with Google® or other smart devices or systems. The locating device is Wi-Fi enabled and can be placed on an object in the home using a means of securement, such as an adhesive. When the user speaks out loud asking their digital assistant to locate the missing item, the digital assistant will activate the locating device through Wi-Fi and the locating device will emit an audible or other alert to help lead the user to the missing item. Multiple locating devices and attachment means may be used simultaneously.

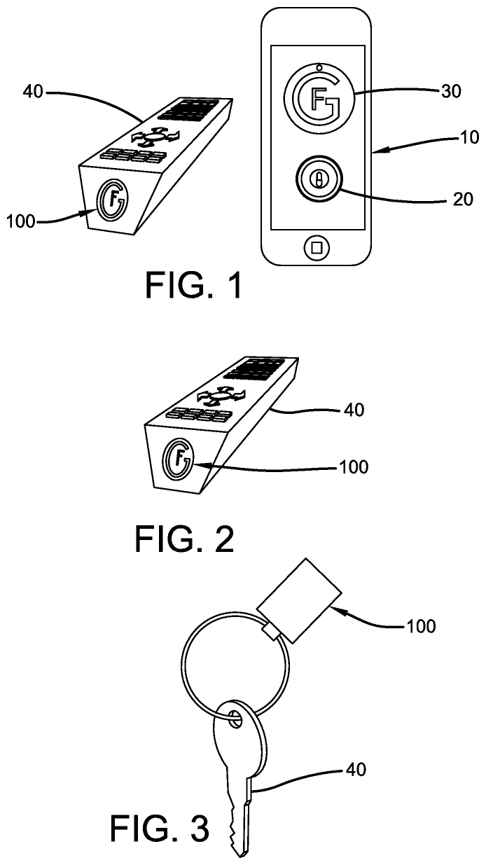

FIGS. 1-3 illustrate a locating device 100 of the present invention for use in locating an object to be located 40. The object to be located 40 may be a television remote as illustrated in FIGS. 1 and 2, a set of keys as illustrated in FIG. 3, or any other object commonly lost or misplaced around a residence, such as an electronic device, a phone, a wallet, and the like. The locating device 100 is usable with a digital assistant 20 typically stored on or activated through a smart device 10, such as a smart phone, a tablet, a computer, a smart speaker, and the like. The digital assistant 20 is an artificial intelligence-powered virtual assistant, such as Google Assistant®, Amazon Alexa®, Apple Siri®, and the like. The locating device 100 is configured to pair with the digital assistant 20 wirelessly via Wi-Fi, RFID, or Bluetooth technology.

The locating device 100 may be paired to the digital assistant 10 using a mobile application 30. The mobile application 30 may be comprised of a plurality of features that includes without limitation the ability to allow the digital assistant 20 to connect to and communicate with the locating device 100. This includes but is not limited to providing data about the object to be tracked 40, such as a name, and tying that data to the specific locating device 100 used on the object to be located 40. The mobile application also provides a means to transfer data and information related to the locating device 100 and the object to be located 40 to the smart device 10.

As illustrated in FIG. 5, the locating device 100 comprises a tracking component 110 and a location indicating component 120. The tracking component 110 is configured to communicate wirelessly with the digital assistant 20. The tracking component 110 comprises a communication receiving element 112 and a communication transmitting element 114. The communication transmitting element 114 is used to pair the locating device 100 with the digital assistant 20 via the mobile application 30. The communication receiving element 112 is used to receive a wireless communication or electronic or digital instruction from the digital assistant 20. The locating device 100 further comprises a power source 130 embedded within the locating device 100 in electrical communication with both the tracking component 110 and the location indicating component 120. The power source 130 is typically an embedded battery that may be wirelessly chargeable.

The location indicating component 120 is in electronic communication with the communication receiving element 114. A voice command from a user initiates a communication between the digital assistant 20 and the tracking component 110. Once the communication receiving element 112 of the tracking component 110 receives the communication, the tracking component 110 activates the location indicating component 120. The location indicating component 120 comprises a speaker 122. The location indicating component 120 may further comprises at least one light emitting element 124. When the location indicating component 120 is activated, the speaker 122 emits an audible alert indicating the location of the object to be located 40. The audible alert could be a series of beeps, noises, tones, or words that the user may listen for to indicate the position of the object to be located 40.

Alternatively, when the location indicating element 120 is activated, the light emitting element 124 would emit a visible alert indicating the location of the object to be located. The light emitting element 124 may be a low power lamp, such as a light emitting diode (LED). The light emitting element 124 could illuminate or flash in a pattern to indicate the position of the object to be located 40. Alternatively, the location indicating component 120 could emit both an audible alert and a visual alert simultaneously. Additionally, the locating device 100 would work the same to connect a smart light bulb (not shown) to the digital assistant 20 to turn the smart light bulb on and off.

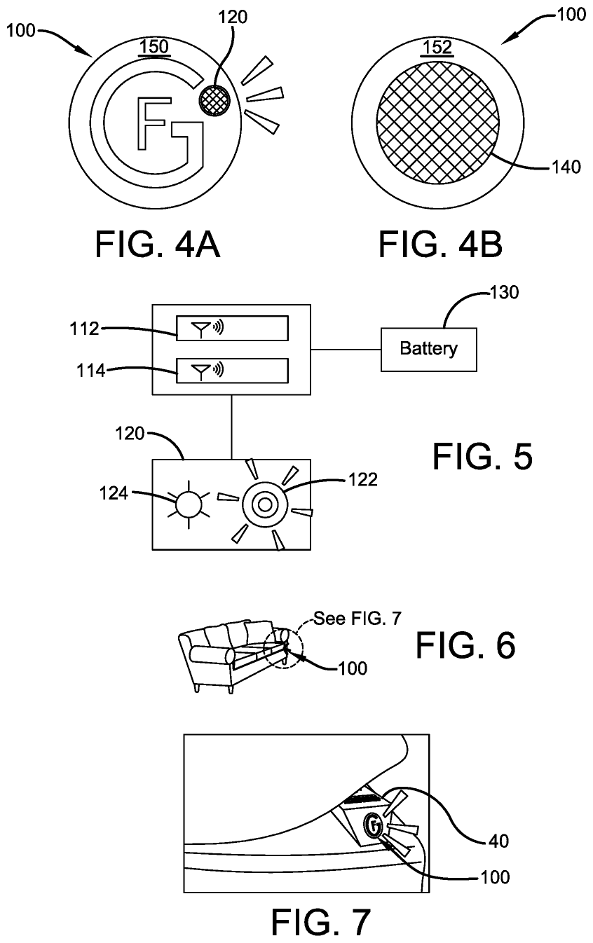

As illustrated in FIG. 4B, the locating device 100 further comprises an attachment component 140. The attachment component 140 is a mechanical or adhesive fastener. The attachment component 140 is used to removably attach the locating device 100 to the object to be located 40. In one embodiment, the attachment component 140 is a double sided adhesive sticker attachable to a back side 152 of the locating device 100. The adhesive sticker would then secure the locating device 100 to the object to be located 40. In this embodiment, the location indicating component 120 would penetrate a front side 150 of the locating device 100 as illustrated in FIG. 4A. Alternatively, the locating device 100 could also sit on a base (not shown) and it would be removed by twisting the it from the base. The base would be attached by some form of adhesive. The locating device 10 can also be attached to a chain (not shown).

To use the locating device 100, the user first pairs the locating device 100 via the communication transmitting element 114 of the tracking component 110 with the digital assistant 20 on the smart device 10 using the mobile application 30 as illustrated in FIG. 1. The pairing will match the locating device 100 with the particular object to be located 40, such as a television remote. Once paired, the locating device 100 is attached to the object to be located 40 using the attachment component 140. Then the object to be located 40 is used throughout daily life as needed until it is unable to be located.

As illustrated in FIGS. 6 and 7, the user contacts the digital assistant 20 using a voice command, such as: “Google Assistant, please find my television remote.” The digital assistant 20 then transmits a wireless communication via Wi-Fi or Bluetooth to the communication receiving element 112 of the tracking component 110 instructing the location indicating component 120 to activate. The location indicating component 120 then emits an audible or visual alert that the user can track to locate the object to be located 40.

It is contemplated that the locating device 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the forgoing, the locating device 100 of the present invention and its various structural components can be of any suitable size, shape, and configuration as is known in the art without affecting the overall concept of the invention, provided that it accomplishes the above stated objectives. One of ordinary skill in the art will appreciate that the shape and size of the locating device 100 and its various components and material, as shown in the FIGS. are for illustrative purposes only, and that many other shapes and sizes of the locating device 100 are well within the scope of the present disclosure. Although the dimensions of the locating device 100 are important design parameters, the locating device 100 and its components may be of any shape or size that ensures optimal performance during use and/or that suits user need and/or preference

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locating device for use with a digital assistant, the locating device comprising:
a tracking component for communicating with the digital assistant;
a location indicating component; and
an attachment component for attaching the locating device to an object to be located.

2. The locating device of claim 1, wherein the locating device is Wi-Fi enabled.

3. The locating device of claim 1, wherein the locating device is Bluetooth enabled.

4. The locating device of claim 1, wherein the digital assistant is an artificial intelligence-powered virtual assistant.

5. The locating device of claim 1, wherein a voice command from a user initiates a communication between the digital assistant and the tracking component to activate the location indicating component.

6. The locating device of claim 1, wherein the location indicating component is configured to emit an audible alert.

7. The locating device of claim 1, wherein the location indicating component is configured to emit a visual alert.

8. A locating device for use with a digital assistant, the locating device comprising:
a tracking component comprising a communication receiving element and a communication transmitting element for communicating with the digital assistant;
a location indicating component; and
an attachment component for attaching the locating device to an object to be located.

9. The locating device of claim 8, wherein the locating device is Wi-Fi enabled.

10. The locating device of claim 8, wherein a voice command from a user initiates a communication between the digital assistant to the communication receiving element of the tracking component to activate the location indicating component.

11. The locating device of claim 8, wherein the location indicating component comprises a speaker.

12. The locating device of claim 8, wherein the location indicating component comprises a light emitting element.

13. The locating device of claim 8, wherein the location indicating component is configured to emit an audible alert and a visual alert.

14. The locating device of claim 8, wherein the attachment component is removably attachable to the object to be located.

15. The locating device of claim 8, wherein the attachment component is an adhesive fastener.

16. A Wi-Fi enabled locating device configured to pair with a digital assistant, the Wi-Fi enabled device comprising:
a tracking component comprising a communication receiving element and a communication transmitting element for communicating with the digital assistant;
a location indicating component;
an attachment component for attaching the locating device to an object to be located; and
a power source.

17. The Wi-Fi enabled locating device of claim 16, wherein a voice command from a user initiates a communication between the digital assistant to the communication receiving element of the tracking component to activate the location indicating component.

18. The Wi-Fi enabled locating device of claim 17, wherein the location indicating component is configured to emit an audible alert or a visual alert.

19. The Wi-Fi enabled locating device of claim 16, wherein the power source is chargeable.

20. The Wi-Fi enabled locating device of claim 16, wherein the attachment component is an adhesive fastener.
